(19) United States
(12) Patent Application Publication
(10) Pub. No.: US 2016/0062756 A1
(43) Pub. Date: Mar. 3, 2016

(54) HARDWARE AND SOFTWARE ARCHITECTURE FOR ENABLING OPTIMIZING TECHNICAL CAPABILITIES IN A DATABASE

(71) Applicant: Vendita Technology Group, Inc., Toledo, OH (US)

(72) Inventor: William Arnold Smith, Genoa, OH (US)

(21) Appl. No.: 14/831,221

(22) Filed: Aug. 20, 2015

Related U.S. Application Data
(60) Provisional application No. 62/041,824, filed on Aug. 26, 2014.

(51) Int. Cl. G06F 9/445; H04L 29/08

(52) U.S. Cl. CPC G06F 8/61; H04L 67/1097

(57) ABSTRACT

An apparatus and method for autonomously constructing and provisioning a database server is disclosed. A hardware configuration is assembled, including at least one flexible system manager for configuring and monitoring the system, and at least one chassis management module. The at least one chassis management module autonomously executes a first set of instructions to provide a hardware configuration on a computing chassis. The at least one flexible system manager autonomously executes a second set of instructions to install and configure an operating system to run on the computing chassis. The at least one flexible system manager autonomously executes a third set of instructions to install and configure a database server to run on the computing chassis.

### CROSS-REFERENCE TO RELATED APPLICATION

This application claims the benefit of priority of U.S. Provisional Patent Application Ser. No. 62/041,824 filed on Aug. 26, 2014, hereby incorporated herein by reference in its entirety.

### FIELD

This invention relates to an apparatus for optimizing technical capabilities in a database. More particularly, the invention relates to hardware architecture and custom developed software architecture for enabling fast construction, provisioning, optimized performance, and server management of database servers.

### BACKGROUND

In recent years, cloud computing networks have become an increasingly popular alternative to locally-based computing. Cloud computing refers to a computing model for enabling on-demand network access to a shared pool of configurable information technology (IT) capabilities or resources (e.g., networks, servers, storage, applications, and services) that can be rapidly provisioned and released, e.g., with minimal management effort or service provider interaction. Cloud computing allows users to access technology-based services from a network cloud without knowledge of, expertise with, or control over the technology infrastructure that supports them, much as consumers of electric utilities are agnostic as to details of the underlying electrical grid. The cloud is a service provider's offering of abstracted computing-related services. The cloud computing model generally enables on-demand computing self-service, ubiquitous network access, location independent resource pooling, rapid elasticity (e.g., quick demand-based resource scaling), and measured computing service.

Additionally, with cloud computing, a physical computer or server no longer needs to be provisioned as a static resource dedicated to a particular application (or set of applications). Instead, a physical machine can be subdivided into its component parts—processor, memory, storage, and network resources—and these parts can be flexibly arranged to create purely logical combinations of resources dedicated to perform particular functionalities.

A cloud computing network may be implemented as a high-speed, special purpose network that interconnects different kinds of data storage devices with associated data servers on behalf of a large network of users. In many cloud computing environments, an administrative user manages user access to cloud resources, such as applications and storage, using a management software program. The administrative users are typically administrative personnel themselves, who need to configure, monitor, and manage some portion of the Storage Area Network (SAN) as part of their job responsibility.

Installing and linking data storage devices to database servers for cloud-based applications is difficult and requires particular expertise. In some instances, hardware choices made by a user may introduce conflicts or other difficulties that impede effective execution of the database software. Even if the hardware and the software are compatible, the hardware requires installation of an operating system that is configured in a way that ensures sufficient resources are available to run the database software. In some instances, there are hundreds of hardware parameters that must be set. Similarly, memory configurations, and the way memory accesses and utilizes physical memory from storage devices, must be set in a way that is both compatible with the database software and that does not affect performance of the database software. A level of technical competence and expertise is also required to install and configure database software and database servers, which may not always be available. The level of technical competence required is further increased because each database installation requires configuration and installation parameters specific to the chosen hardware, which is generally unavailable from database software providers. Thus, installers and technical personnel are forced to rely on experimentation with configuration and installation parameters when attempting to optimize system performance. Using experimentation, optimized system performance is only achieved via experience and testing, further increasing the level of technical expertise necessary to install and configure database installations. Finally, even if an installer develops a level of technical expertise necessary to optimize database system installation, the installer generally lacks any expertise or knowledge necessary to automate the configuration and installation processes.

Moreover, there are multiple platforms used to construct database servers. For example, conventional servers may utilize the X86 family of processors, which require a first configuration, a first operating system, and a first installation process. Other conventional servers may utilize one or more Reduced Instruction Set Computing (RISC) based processors, which require a second configuration, a second operating system, and a second installation process that is nothing like the first configuration, the first operating system, and the first installation process required by the X86 based processors. No infrastructure exists for providing a system and method to construct and configure database servers regardless of the processor family used for the servers. Additionally, no infrastructure exists for providing a system and method to construct and configure database servers utilized both the X86 family of processors and one or more RISC based processors.

Accordingly, there exists a need in the art for a cloud computing network having hardware and software, wherein the hardware can be autonomously and rapidly provisioned by the software for use as a database server. There further exists a need in the art for a cloud computing network having hardware and software, wherein the hardware can be autonomously and rapidly provisioned by the software for use as a database server, where the autonomous and rapid provisioning by the software is not dependent upon the class of processor used in the hardware. There further exists a need in the art for a cloud network being optimized to perform data processing. Additionally, there exists a need in the art for a cloud computing network having server management capability, wherein a software is capable of monitoring the network for performance and license usage.

### SUMMARY

In concordance with the instant disclosure, an apparatus and method for autonomously and rapidly provisioning hardware and software for use as a database server independent of the class of processor used in the hardware, that is further optimized to perform data processing, that is further capable of monitoring the database server for performance and license usage, has surprisingly been discovered.

The apparatus includes a storage server and a computing chassis. The computing chassis includes a storage area network, at least one compute node having at least one central processor, at least one network switch configured to provide connectivity to the compute nodes to provide network access to the servers, at least one flexible system manager for configuring and monitoring the system, and at least one chassis management module. The at least one chassis management module autonomously executes a first set of instructions to provide a hardware configuration to the storage area network, the at least one compute node including the at least one central processor, and the at least one network switch. The at least one flexible system manager autonomously executes a second set of instructions to install and configure an operating system to run on the computing chassis. The at least one flexible system manager autonomously executes a third set of instructions to install and configure a database to run on the computing chassis.

In one embodiment, the at least one flexible system manager executes fourth set of instructions to autonomously install and configure at least one of a health check process and a license management process.

A method of constructing a specialized database management system is also disclosed. According to the method, a hardware architecture is selected. The hardware architecture includes a storage area network, at least one compute node, at least one network switch, and at least one flexible system manager. The hardware architecture is assembled on a computing chassis that includes at least one chassis management module. The hardware architecture is configured by autonomously executing a first set of instructions using the at least one chassis management module. An operating system is installed and configured to run on the hardware architecture by autonomously executing a second set of instructions using the at least one flexible system manager. A database server system is installed and configured to run on the hardware architecture by autonomously executing a third set of instructions using the at least one flexible system manager.

In one embodiment, at least one of a health check process and a license management process is installed and configured by autonomously executing a fourth set of instructions using the at least one flexible system manager.

### BRIEF DESCRIPTION OF THE DRAWINGS

The above, as well as other advantages of the present disclosure will become readily apparent to those skilled in the art from the following detailed description of the preferred embodiments when considered in light of the accompanying drawings, in which:

FIG. 1 illustrates an overview of a hardware architecture for implementing an apparatus and method for autonomously and rapidly provisioning hardware and software for use as a database server, according to an embodiment of the disclosure;

FIG. 2 illustrates an overview of autonomously and rapidly provisioned hardware and software for use as a database server, according to an embodiment of the disclosure; and

FIG. 3 illustrates an exemplary process flow chart for a method of autonomously and rapidly provisioning hardware and software for use as a database server, according to an embodiment of the disclosure.

### DESCRIPTION OF THE PREFERRED EMBODIMENT

The following detailed description and appended drawings describe and illustrate various exemplary embodiments of the disclosure. The description and drawings serve to enable one skilled in the art to make and use the disclosure, and are not intended to limit the scope of the disclosure in any manner. In respect of the methods disclosed, the steps presented are exemplary in nature, and thus, the order of the steps is not necessary or critical, unless otherwise disclosed.

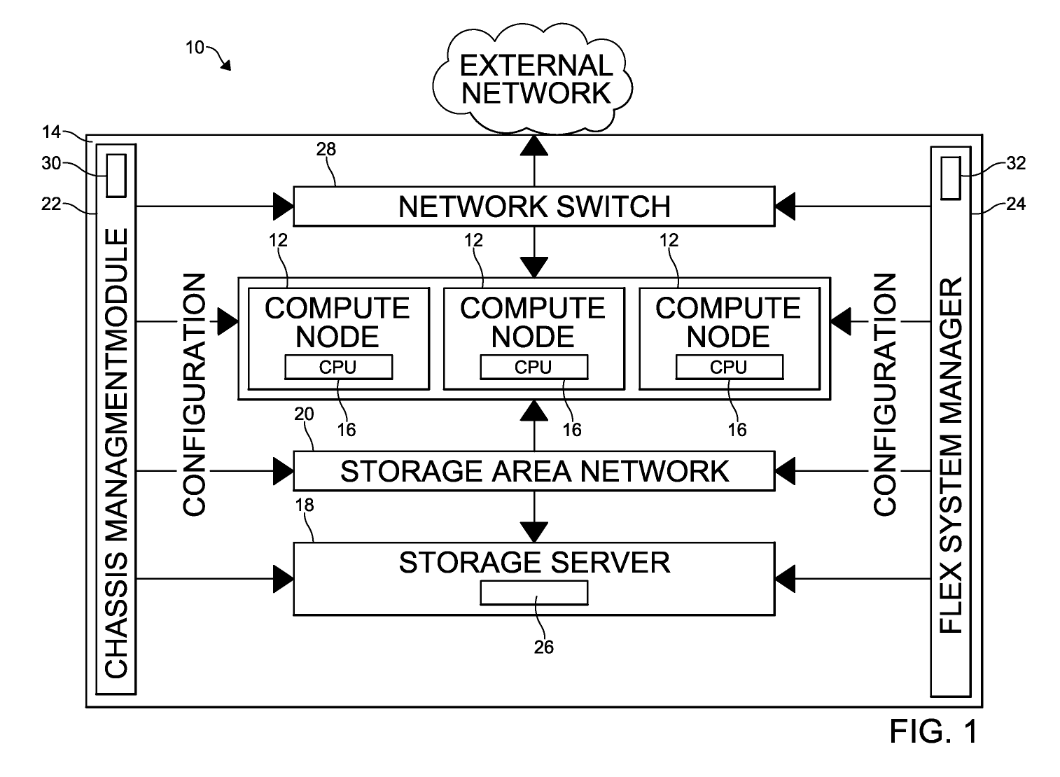

FIG. 1 provides an overview of a hardware architecture 10 for implementing various features of an embodiment of an apparatus and method for autonomously and rapidly provisioning hardware and software for use as a database server system. At least one compute node 12 is installed into a hardware chassis 14. Each at least one compute node 12 includes server hardware including at least one processor 16. It is understood that the at least one processor 16 may be any conventional processor. As a non-limiting example, the at least one processor 16 may be a processor from the X86 family of processors, or it may be a processor from the RISC family of processors. It is further understood that if more than one of the at least one compute node 12 is installed into the hardware chassis 14, each of the more than one of the at least one compute node 12 may include the same or different processors as desired.

A storage server 18 is installed within the hardware chassis 14. In one embodiment, the storage server 18 may be configured to utilize slower storage for disk activity that does not require rapid storage. In another embodiment, the storage server 18 contains storage configuration instructions 26 for the storage server and for a storage area network 20 that also is installed within the hardware chassis 14. The storage configuration instructions 26 map physical storage to logical entities. The storage area network 20 is configured to work with the storage server 18, and is capable of providing connectivity between the at least one compute node 12, including the at least one processor 16, and the storage server 18. The configuration of the storage server 18, the at least one compute node 12, and the storage server 18 is discussed in further detail hereinbelow.

At least one chassis management module 22 is installed within the hardware chassis 12. The at least one chassis management module 22 is capable of configuring the hardware chassis 12 by introducing chassis configuration instructions 30 included within the at least one chassis management module 22 or provided through an interface provided in the at least one chassis management module 22. The at least one chassis management module 22 and the chassis configuration instructions 30 may additionally introduce configuration information for all of the hardware interconnections of the various equipment contained within the hardware chassis 12, typically through the interface provided by the at least one chassis management module 22.

At least one flexible system manager 24 is installed within the hardware chassis 12. The at least one flexible system manager 24 is capable of configuring and monitoring the system 10 by introducing system configuration instructions 32 included within the at least one flexible system manager 24 or provided through an interface provided in the at least one flexible system manager 24. The at least one flexible system manager 24 thereby utilizes the system configuration instructions 32 to configure the hardware architecture 10. Finally, at least one network switch 28 is installed within the hardware chassis 12. The at least one network switch 28 is capable of providing connectivity to the at least one compute node 12, and is further capable of providing network access to the hardware architecture 10. It is understood that the at least one network switch 28 may also be capable of providing connectively between one or more of the at least one compute node 12 for configurations that require clustered server resources. Together, the at least one chassis management module 22 and the at least one flexible system manager 24 are capable of providing fast provisioning capability, optimized performance capability, and server management capability.

### Example Hardware Architecture:

Favorable results have been achieved utilizing an IBM Pureflex chassis as the hardware chassis 14, which acts as a physical container for the at least one compute node 12, the at least one network switch 28, the storage area network 20, the at least one chassis management module 22, and the at least one flexible system manager 24. The IBM Pureflex chassis is advantageous because no configuration via web browser or command line interface is required for this hardware. Additionally, favorable results have been achieved using an IBM V7000 Storage Server as the storage server 18 used with the IBM Pureflex chassis. The IBM V7000 contains the physical disks used for the database server solution described hereinabove, and contains configuration data for the system and for the software. The configuration sets of instruction are used to map the physical storage of the IBM V7000 to logical entities. Additionally, the storage area network 20 is configured to provide access to the storage from computing resources. The configuration of the storage area network 20 is optimized for the database server installed on the system, and is designed to access the logical mappings on the IBM V7000 storage server. The IBM Pureflex system includes two chassis management modules 22. Hardware configurations, including the various sets of instruction 26, 30, 32, are loaded using the interface provided by the chassis management modules 22. On the IBM Pureflex chassis, the computer hardware used for the at least one network switch 28 is located in bays 1 and 2, and the computer hardware used for the storage area network 20 is located in bays 3 and 4 of the Pureflex Chassis. Favorable results have been achieved using an IBM FC5200 16GB SAN Scalable Switch as the hardware for the storage area network 20. Favorable results have also been achieved with server hardware using the IBM POWER family of processors and the Intel X86 Xeon family of processors as the at least one compute node 12.

Fast provisioning is the capability to rapidly provision hardware to be used as a database server system. In one embodiment, the database server system is an Oracle database server system. Fast provisioning capability also enables a variety of enterprise software installations to be rapidly deployed. As non-limiting examples, the enterprise software installations may include one or more of Oracle WebLogic, Oracle Virtual Machine, Oracle Hyperion, Oracle EBS, and MangoDB. Fast provisioning is enabled via configuration software developed and incorporated into the storage server 18 or introduced through interfaces in one or more of the at least one chassis management module 22 as chassis configuration instructions 30 and through the at least one flexible system manager 24 as system configuration instructions 32. In one embodiment, the chassis configuration instructions 30 are executed to perform hardware configuration, the system configuration instructions 32 are executed to perform software installation and software configuration, and the storage configuration instructions 26 are executed to map physical storage to logical entities.

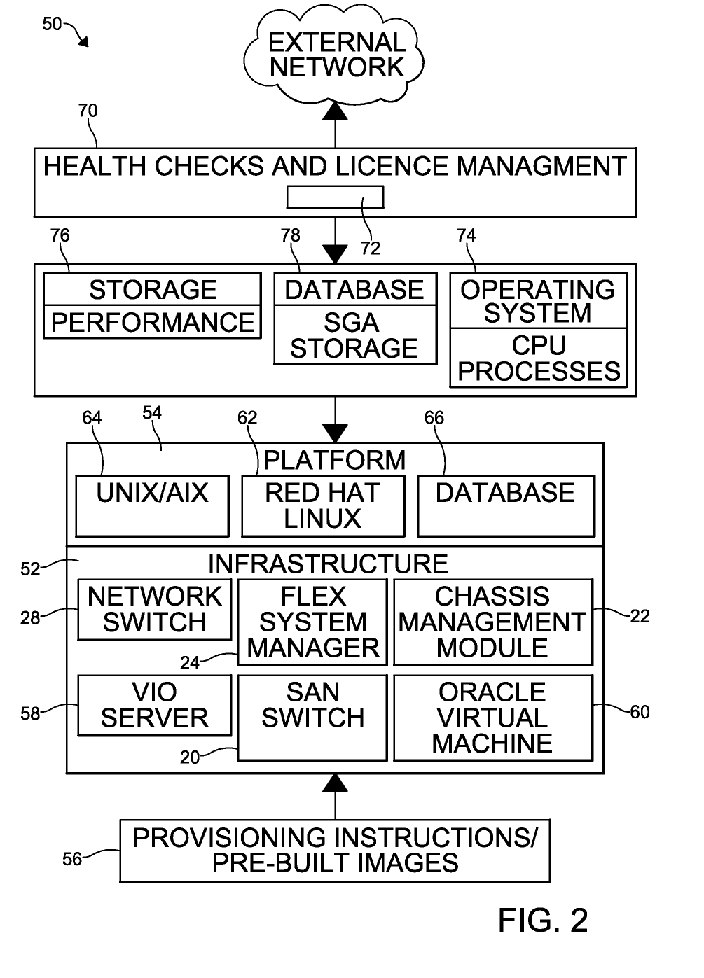

An overview of autonomously and rapidly provisioned hardware and software for use as a database server is shown with reference to FIG. 2. Hardware and software configuration provisioning 50 is grouped into two areas, infrastructure provisioning 52 and platform provisioning 54. Accordingly, a set of autonomous provisioning instructions 56 are utilized to accomplish both infrastructure provisioning 52 and platform provisioning 54. The autonomous provisioning instructions 56 may include one or more of the storage configuration instructions 26, the chassis configuration instructions 30, and the system configuration instructions 32.

Infrastructure provisioning 52 includes installing, configuring, and provisioning the hardware architecture 10 (FIG. 1), including all hardware, storage, network, and hypervisor systems. Infrastructure provisioning 52 must occur before any platform items can be installed. The infrastructure provisioning is typically accomplished by executing the chassis configuration instructions 30 utilizing the at least one chassis management module 22, and if necessary, executing the storage configuration instructions 26 utilizing the storage server 18 (see FIG. 1). After infrastructure provisioning 52 is completed, then all platform provisioning 54 may occur. Platform provisioning 54 is typically accomplished by executing the system configuration instructions 32 utilizing the at least one flexible system manager 24 (see FIG. 1).

After assembling and configuring the hardware architecture 10, as described above with reference to FIG. 1, further infrastructure provisioning and configuration utilizes the at least one chassis management module 12. As a non-limiting example, one or both of the at least one chassis management module 22 and the at least one flexible system manager 24 may provide one or more of a web based user interface and a command line interface. Chassis configuration instructions 30 specific to the selected and assembled at least one network switch 28, the storage area network switch 20, the at least one compute node 12, and the at least one flexible system manager 24 are implemented as parts of the provisioning instructions 56 through any of the interfaces provided by the at least one chassis management module 22. As a non-limiting example, the storage area network switch 20 is configured by executing the chassis configuration instructions 30 as part of an initial system setup. The portion of the chassis configuration instructions 30 utilized to configure the storage area network switch 20 is typically used only once, and is usually never used again. As a further non-limiting example, the at least one network switch 28 is configured by executing the chassis configuration instructions 30 as part of an initial system setup. The portion of the chassis configuration instructions 30 utilized to configure the at least one network switch 28 is typically used only once, and is usually never used again.

As part of infrastructure provisioning 52, a virtual I/O server 58, or VIOS 58, is configured by executing the chassis configuration instructions 30 or the system configuration instructions 32, or both. In one embodiment, the VIOS 58 is configured to support database operations and operation of the database server, and is further designed to comply with certain business drivers, including high availability, and fault tolerance. In one embodiment, high availability and fault tolerance is provided by implementing more than one VIOS server 58, with the more than one VIOS server 58 implemented as a redundant VIOS server 58.

As noted hereinabove, certain conventional database servers may utilize the X86 family of processors, which require a first configuration, operating system, and installation process, while other conventional servers may utilize one or more Reduced Instruction Set Computing (RISC) based processors, which require a second configuration, operating system, and installation process that is nothing like the first configuration, operating system, and installation process required by the X86 based processors. If at least one of the at least one compute node 12 utilizes the X86 family of processors, the chassis configuration instructions 30 or the system configuration instructions 32, or both, may include a requirement to install an Oracle Virtual Machine 60 on X86 nodes to host other operating systems that require the X86 processor. As a non-limiting example, the Oracle Virtual Machine 60 may be required for installation of Red Hat Linux 62 on an at least one compute node 12 utilizing the X86 family of processors. The portion of the chassis configuration instructions 30 or the system configuration instructions 32 utilized to configure the Oracle Virtual Machine 60 is typically used only once as part of the initial system setup, and is usually never used again.

After completion of the portion of the provisioning instructions 56 related to infrastructure provisioning 52, the portion of the provisioning instructions 56 related to platform provisioning 54 is implemented, typically by executing the system configuration instructions 32 utilizing the at least one flexible system manager 24. As non-limiting examples, platform provisioning 54 may include installation of additional software programs including operating systems, database servers, application servers, and application software, as, for example, Hyperion or Oracle E-Business Suite. The platform provisioning 54 additionally includes installation of at least one database server software 66, such as an Oracle database, Mongo DB, or Endeca. The database server software 66 can be installed on the at least one compute node 12 having either RISC based and X86 based processors 16.

As noted hereinabove, if at least one of the at least one compute node 12 utilizes the X86 family of processors, the system configuration instructions 32 may include a requirement to install Red Hat Linux 62. Similarly, if the at least one of the at least one compute node 12 utilizes the RISC family of processors, the system configuration instructions 32 may include a requirement to install a UNIX operating system 64. As a non-limiting example, the UNIX operating system 64 may include the IBM AIX operating system to power the IBM family of RISC-based processor. In one embodiment, the system configuration instructions 32 further include enhancements and features that add to the usability and operating system performance of the UNIX operating system, including the IBM AIX operating system. In another embodiment, the system configuration instructions 32 include a standard deployment of a UNIX operating system with the database software and the overall operating system performance.

Upon completion of the infrastructure provisioning 52 and the platform provisioning 54, an optional health checks and license management module 70 may be installed and configured autonomously. The health checks and license management module 70 provides capabilities that are utilized by managers of the database server after an installation is completed. In one embodiment, the health checks and license management module executes an set of instructions 72 that reports performance data and information to a central location for review by technical professionals. The health checks and license management module may be optionally implemented through executing the system configuration instructions 32 utilizing the at least one flexible system manager 24. Advantageously, the health checks and license management module 70 is capable of being executed on the operating systems of both X86 based processors and RISC based processors. In one embodiment, the health checks and license management module 70 is provided in one or more of the Python programming language, Oracle PL/SQL, and Unix/Linux shells scripts, to allow the health checks and license management module 70 to be executed on either or both of X86 based processors and RISC based processors.

The health checks and license management module 70 operates to collect information related to the stability and status of the operating system, indicated by reference 74 of FIG. 2, proper operation of the storage and database server, indicated by reference 76 of FIG. 2, and the usage of Oracle licenses, indicated by reference 78 of FIG. 2. The health checks and license management module 70 promotes optimized performance of the database server to perform data processing. Performance of a database server is usually measured in terms of metrics that involve time required to access data. By autonomously configuring the database server, and by enabling installation of the health and license management module 70, the database server is optimized to deliver superior end user experience, with applications and business reports that execute faster. In particular, the health checks portion of the health checks and license management module 70 examine aspects of the operating system 74, the storage and database server 76, and the database software 78, detecting critical issues including, but not limited to, storage at or near capacity, high CPU utilization, and database tuning issues, database objects issues, and a number of other causes of performance or stability issues. The health checks and license management module 70 reports any critical issued detected to technical personnel.

The license management portion health checks and license management module 70 provides license management for any software included on the database server that requires such management. In particular, the license management portion of the health checks and license management module 70 collects information regarding the hardware and operating system 74 for a server, along with information regarding the usage of database software 78, database software features, and database software management packs. Optionally, the license management information may be collected into an extensible markup language document, and may be transmitted to technical personnel for analysis. The license management information may also be reviewed in a customer portal.

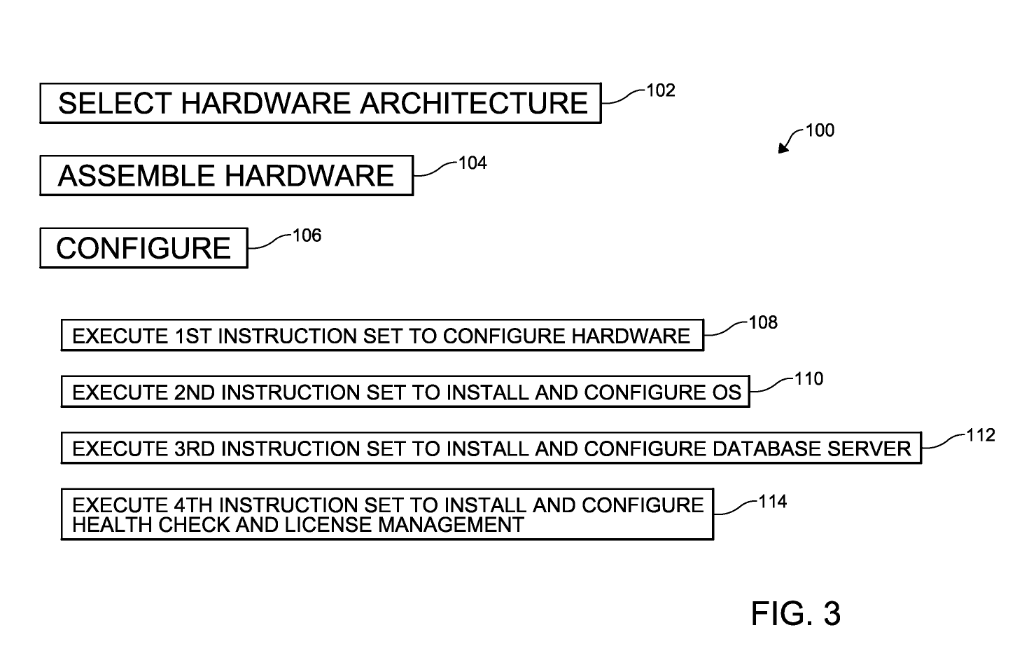

A method 100 of autonomously and rapidly provisioning hardware and software for use as a database server is also disclosed with reference to FIG. 3. In the first step 102, a hardware architecture is selected for the database server. As described hereinabove with reference to FIG. 1, the hardware architecture may include a storage area network 20, at least one compute node 12, at least one network switch 28, at least one chassis management module 22, and at least one flexible system manager 24. Once selected, the hardware architecture is assembled on a computing chassis in step 104. In step 106, one or more aspects of the database server are installed and configured autonomously. The particular aspects installed for a given database server are selected by the assembler and may be specified for a given database user.

In step 108, the hardware architecture may be configured by autonomously executing a first set of instructions using the at least one chassis management module 22. Configuration of the hardware ensures compatibility between different hardware components, and ensures proper function of the database server. In one embodiment, the configuration of the hardware architecture is specified as a certain combination of components to achieve an economic and self-contained package.

Once the hardware architecture is assembled and configured, an operating system must be installed and configured in a way to ensure sufficient resources are available to run a database. The operating system is installed and configured in step 110 by executing a second set of instructions to install and configure the operating system. Any combination of hardware architecture and operating system requires hundreds of parameters to be properly managed and configured. According to the present disclosure, all of the parameters necessary to install and configure the operating system are autonomously adjusted in step 110 by executing the second set of instructions using the at least one flexible system manager 24.

In step 112, a third set of instructions is executed using the at least one flexible system manager 24 to autonomously install and configure a database server system to run on the hardware architecture. According to the present disclosure, all of the parameters necessary to install and configure the database server are autonomously adjusted in step 112.

Optionally, a fourth set of instructions may be executed by the at least one flexible system manager 24 in step 114. The fourth set of instructions autonomously installs and configures at least one of a health check process and a license management process.

By combining the first set of instructions, the second set of instructions, the third set of instructions, and the optional fourth set of instructions with the at least one chassis management module 22 and the at least one flexible system manager 24 to autonomously provision, implement and run a database server system on hardware, the method of the present disclosure ensures that all requirements for installing and for ensuring performance of a database server are met. As a result, no special or institutional knowledge is required to implement the complex database server system, or to run and maintain the database server system on any given hardware. Moreover, because no special or institutional knowledge is required to implement the database server system, the level of skill necessary to provide database server system support is reduced, leading to readily available system support continuity, and reducing or eliminating an enterprise risk that a departure of one or more knowledgeable support technicians may leave a database server system unsupported.

Additionally, the apparatus and method of the present disclosure guarantees high performance and integrity because the method optimizes selection of hardware, software and other aspects of the system. The present disclosure further enables an easily implementable database server system may be shipped pre-built, ready to be simply powered up at the database server system destination. Accordingly, the present disclosure provides a method for providing a specialized database server system that eliminates installation and configuration time, leading to a rapid time to value for the customer. Thus, the apparatus and method of the present disclosure creates a deterministic and repeatable commercial process for constructing and configuring a specialized database server system for use in creating and managing any aggregation of data, including rapid retrieval of the aggregation of data and the creation of data warehouses. The apparatus and method of the present disclosure may therefore be utilized to construct both transactional database server systems and decision support database server systems, as required.

From the foregoing description, one ordinarily skilled in the art can easily ascertain the essential characteristics of this disclosure and, without departing from the spirit and scope thereof, make various changes and modifications to the disclosure to adapt it to various usages and conditions.

What is claimed is:

1. An apparatus comprising:
a storage server and a computing chassis, the computing chassis further comprising:
at least one chassis management module; and
at least one flexible system manager for configuring and monitoring the apparatus;
wherein the at least one chassis management module autonomously executes a first set of instructions to provide a hardware configuration to the computing chassis;
wherein the at least one flexible system manager autonomously executes a second set of instructions to install and configure an operating system to run on the computing chassis; and
wherein the at least one flexible system manager autonomously executes a third set of instructions to install and configure a database server system to run on the computing chassis.

2. The apparatus of claim 1, wherein the at least one flexible system manager autonomously executes a fourth set of instructions to install and configure at least one of a health check process and a license management process on the computing chassis.

3. The apparatus of claim 1, wherein the at least one central processor is one of an X86 based processor and a RISC based processor.

4. The apparatus of claim 1, wherein the at least one central processor includes at least one X86 based processor and at least one RISC based processor.

5. The apparatus of claim 1, wherein the database server system is one of a transactional database server system and a decision support database server system.

6. The apparatus of claim 1, wherein the first set of instructions, the second set of instructions, and the third set of instructions are stored on the storage server.

7. An apparatus comprising:
a storage server and a computing chassis, the computing chassis further comprising:
at least one compute node having at least one central processor;
a storage area network configured to provide connectivity between the at least one compute node and the storage server;
at least one network switch configured to provide connectivity between the at least one compute node and an external network to provide network access to the apparatus;
at least one chassis management module; and
at least one flexible system manager for configuring and monitoring the apparatus;
wherein the at least one chassis management module autonomously executes a first set of instructions to provide a hardware configuration to the storage area network, the at least one compute node including the at least one central processor, and the at least one network switch;
wherein the at least one flexible system manager autonomously executes a second set of instructions to install and configure an operating system to run on the computing chassis; and
wherein the at least one flexible system manager autonomously executes a third set of instructions to install and configure a database server system to run on the computing chassis.

8. The apparatus of claim 7, wherein the at least one flexible system manager autonomously executes a fourth set of instructions to install and configure at least one of a health check process and a license management process on the computing chassis.

9. The apparatus of claim 8, wherein the first set of instructions, the second set of instructions, the third set of instructions, and the fourth set of instructions are stored on the storage server.

9. The apparatus of claim 7, wherein the at least one central processor is one of an X86 based processor and a RISC based processor.

10. The apparatus of claim 7, wherein the at least one central processor includes at least one X86 based processor and at least one RISC based processor.

11. The apparatus of claim 7, wherein the database server system is one of a transactional database server system and a decision support database server system.

12. The apparatus of claim 7, wherein the first set of instructions, the second set of instructions, and the third set of instructions are stored on the storage server.

13. A method of constructing a specialized database management system, comprising:
selecting a hardware architecture including at least one flexible system manager ;
assembling the hardware architecture on a computing chassis, the computing chassis including at least one chassis management module;
configuring the hardware architecture by autonomously executing a first set of instructions using the at least one chassis management module;
installing and configuring an operating system to run on the hardware architecture by autonomously executing a second set of instructions using the at least one flexible system manager; and
installing and configuring a database server system to run on the hardware architecture by autonomously executing a third set of instructions using the at least one flexible system manager.

14. The method of claim 13, further comprising the step of:
installing and configuring at least one of a health check process and a license management process by autonomously executing a fourth set of instructions using the at least one flexible system manager.

15. The method of claim 13, wherein the second set of instructions is executed prior to executing the third set of instructions.
